(19) United States
(12) Patent Application Publication
(10) Pub. No.: US 2009/0132406 A1
(43) Pub. Date: May 21, 2009

(54) SYSTEM AND METHOD FOR PAPERLESS LOAN APPLICATIONS

(75) Inventors: William S. Brooks, Bloomfield Hills, MI (US); Andrew F. Schmitt, Birmingham, MI (US); Jason B. Dufner, Howell, MI (US)

Correspondence Address: BROOKS KUSHMAN P.C., 1000 TOWN CENTER, TWENTY-SECOND FLOOR, SOUTHFIELD, MI, 48075, US

(73) Assignee: PAPERLESS OFFICE SOLUTIONS, INC. D/B/A DOCVELOCITY, Troy, MI (US)

(21) Appl. No.: 12/276,011

(22) Filed: Nov. 21, 2008

Related U.S. Application Data
(60) Provisional application No. 60/989,499, filed on Nov. 21, 2007.

(51) Int. Cl. G06Q 40/00

(52) U.S. Cl. 705/35

(57) ABSTRACT

In one embodiment, a system for modifying loan documents may comprise a first computer to receive loan documents, transmit the loan documents to an auto-indexing device, receive an indexed set of loan documents, store the loan documents, and enable modification of the loan documents. In another embodiment, the first computer may transmit the loan documents to a second computer for indexing the loan documents, generating a first indexed set of loan documents, and for storing the loan documents. The first computer may command the second computer to modify the first indexed set of loan documents. In another embodiment, a system for transmitting loan documents to lenders may comprise a first computer to receive a plurality of loan documents, transmit the loan documents to an auto-indexing device, receive a set of loan documents, store the loan documents, and transmit the loan documents to a plurality of lenders.

### CROSS-REFERENCE TO RELATED APPLICATIONS

This application claims the benefit of U.S. provisional application Ser. No. 60/989,499 filed Nov. 21, 2007, the contents of which are incorporated herein by reference.

### BACKGROUND

1. Technical Field

One or more embodiments of the present invention generally relate to paperless loan applications for brokers.

2. Background Art

A number of lenders generally require brokers to insert paper bar codes for indexing various documents within a loan package. The loan packages may be used for obtaining a mortgage on a piece of property or land. The process of manually placing bar codes for different documents within the loan package is very time consuming for the brokers. For example, the loan package may include, but not limited to, a loan application, credit report, disclosure, good faith estimate, requests for an appraisal and survey, etc. The brokers have to physically separate each of the aforementioned documents and generate a bar code for each type of document and physically place the corresponding bar code with the corresponding document for indexing purposes.

One approach to auto-indexing loan documents is disclosed in U.S. Pat. No. 7,146,367 to Shutt (“Shutt”). The Shutt patent discloses a system whereby a particular lender receives loan documents in an electronic format with respect to a particular transaction and auto-indexes the loan documents. The indexed documents are stored in a repository for the lender and the broker to access jointly. The indexed documentation stays in the repository until the transaction between the broker and the lender is completed.

While the Shutt patent provides for a useful auto-indexing system, the broker has limited control over the documents. For instance, the broker is prohibited from modifying or deleting the indexing documents while the indexed documents are in the repository. Additionally, the indexed documents remain confined to the repository even if the broker wishes to provide an electronic copy of the indexed documents to another prospective lender. Due to this prohibition, the broker may have to go through the process of adding bar codes to the paper loan application for indexing in the event the broker intends to submit the loan application to another prospective lender who has different indexing requirements. Further, the broker has to continue to store a paper copy of the indexed loan documents for future reference or for submission to other lenders.

Another approach offered for automatic indexing of loan document is U.S. Publication No. 2007/0118391 to Malaney et al. (“Malaney”) directed to a business method using the automated processing of paper and unstructured electronic documents. Malaney provides a system that takes advantage of the ability to convert unorganized information in the form of paper documents, document images, and electronic documents and converts the information to an organized electronic form referred to as Knowledge Objects. Malaney further discloses the use of forming electronic Business Objects, such as documents and data sets, that may be useful for business decision making and information exchange. The system of Malaney may utilize computerized storage and computerized decision-making systems to enable making more rapid critical business decisions.

While Malaney may be useful for its purposes, Malaney does not provide the ability to modify already electronically indexed loan documents (e.g., renaming and reclassification) or the ability to create new indexed loan documents from an existing indexed loan document while such indexed documents are stored in a repository. Additionally, Malaney does not address the benefit of sending loan documents to a plurality of lenders from a broker based on various lender requirements and/or specifications associated with the loan documents.

### SUMMARY

One aspect of the present invention relates to a system for electronically modifying a plurality of loan documents associated with a loan broker. The system comprises a first computer. The first computer may be configured to receive the plurality of loan documents from a second computer, transmit the plurality of the loan documents to an auto-indexing device for indexing the loan documents to generate a first indexed set of loan documents, receive the first indexed set of loan documents, store the first indexed set of loan documents in a database, and enable the second computer to electronically modify the first indexed set of loan documents to generate a second indexed set of loan documents. In one embodiment, the first computer may be a server.

In some embodiments, the first computer may be further configured to transmit the first indexed set of loan documents to a first lender in response to a first command from the second computer and a second indexed set of loan documents to a second lender in response to a second command from the second computer.

In further embodiments, the first computer may be further configured to electronically modify the first indexed set of loan documents by deleting at least a portion of the first indexed set of loan documents in response to a command from the second computer.

In further embodiments, the first computer maybe further configured to electronically modify the first indexed set of loan documents by removing at least a portion of the first indexed set of loan documents in response to a command from the second computer.

In yet further embodiments, the first computer maybe further configured to generate a loan folder prior to transmitting the plurality of loan documents to the auto-indexing device in response to a command from the second computer. Furthermore, the first computer may be further configured to store at least one of the first or second indexed set of loan documents in the loan folder.

In yet further embodiments, the first computer may be further configured to transmit a preselected portion of the first indexed set of loan documents to a first lender in response to a first command from the second computer.

Furthermore, the first computer maybe further configured to transmit a preselected portion of the second indexed set of documents to a second lender in response to a second command from the second computer.

In further embodiments, the first computer may be further configured to provide to the second computer unrestricted access to the database for electronically modifying the first indexed set of loan documents.

In further embodiments, the first computer maybe further configured to establish predefined access levels to the database with respect to the manner in which the first computer electronically modifies the first indexed set of documents in response to a command from the second computer.

Another aspect of the present invention relates to a system for electronically modifying a plurality of loan documents associated with a loan broker. The system may comprise a first computer. The first computer may be configured to transmit the plurality of loan documents to a second computer for indexing the loan documents, to generate a first indexed set of loan documents, and for storing the first indexed set of loan documents. The first computer may be further configured to command the second computer to electronically modify the first indexed set of loan documents to generate a second indexed set of loan documents. The second indexed set of loan documents may be stored on at least one of the first and the second computers.

In some embodiments, the first computer may be further configured to command the second computer to transmit the first indexed set of loan documents to a first lender, the second indexed set of loan documents to a second lender and/or either of at least the first or second indexed set of loan documents to at least two lenders.

In further embodiments, the first computer may be further configured to command the second computer to electronically modify the first indexed set of loan documents by renaming one or more sections of the first indexed set of loan documents or by deleting one or more sections of the first indexed set of loan documents.

Another aspects of the present invention relates to a system for electronically transmitting a plurality of loan documents for a loan broker to one or more lenders. The system may be comprised of a first computer. The first computer maybe configured to receive the plurality of loan documents from a second computer, transmit the plurality of the loan documents to an auto-indexing device for indexing the plurality of the loan documents to generate a first indexed set of loan documents, receive the first indexed set of loan documents, store the first indexed set of loan documents, and transmit the first indexed set of loan documents to a first plurality of lenders in response to a first command from the second computer.

In some embodiments, the first computer may be further configured to electronically modify the first indexed set of loan documents to produce a second indexed set of loan documents while the first indexed set of loan documents are stored in the first computer. The first computer may be further configured to transmit the second indexed set of loan documents to a second plurality of lenders in response to a second command from the second computer.

### BRIEF DESCRIPTION OF THE DRAWINGS

FIG. 1 is a diagrammatic view of a document upload and automatic indexing system in accordance to an embodiment of the present invention;

FIG. 2 is a block diagram of a loan delivery process between a broker and one or more lenders;

FIG. 3 is a flow diagram representing one of the various embodiments of the loan document modification feature of the present invention;

FIG. 4 is a screen display in a user interface depicting the creation of delivery methods for loan document delivery;

FIG. 5 is a screen display in the user interface depicting a new office setup;

FIG. 6 is a screen display in the user interface depicting a new cabinet setup;

FIG. 7 is a screen display in the user interface depicting document renaming/modification;

FIG. 8 is a screen display in the user interface depicting a new inbox setup;

FIG. 9 is a screen display in the user interface depicting a role assignment;

FIG. 10 is a screen display in the user interface depicting a new user setup;

FIG. 11 is a screen display in the interface depicting a “home page” presented to a user (or broker);

FIG. 12 is a screen display in the user interface depicting a document list for a loan folder;

FIG. 13 is a screen display in the user interface depicting a document tab and document preview;

FIG. 14 is a screen display in the user interface depicting a delivery operation between the broker/borrower and a perspective lender;

FIG. 15 is a screen display in the user interface depicting another delivery operation between the broker/borrower and a perspective lender;

FIG. 16 is a screen display in the user interface depicting another delivery operation between the broker/borrower and a perspective lender;

FIG. 17 is a screen display in the user interface depicting another delivery operation between the broker/borrower and a perspective lender;

FIG. 18 is a screen display in the user interface depicting another delivery operation between the broker/borrower and a perspective lender;

FIG. 19 is a screen display in the user interface depicting another delivery operation between the broker/borrower and a perspective lender;

FIG. 20 is a screen display in the user interface depicting an incoming and outgoing transmissions log for a loan folder;

FIG. 21 is a screen display in the user interface depicting various notes associated with a loan folder;

FIG. 22 is a screen display in the user interface depicting a feature of uploading additional documents to a loan folder;

FIG. 23 is a screen display in the user interface depicting another feature of uploading additional documents to a loan folder; and

FIG. 24 is a screen display in the user interface depicting a feature of indexing loan documents.

### DETAILED DESCRIPTION OF THE ILLUSTRATED EMBODIMENT(S)

A home can be an expensive investment, so it is not surprising that a typical home buyer wants the best deal on their mortgage financing. Most home buyers rely on a mortgage broker to communicate with lenders to find them a good deal. Accordingly, a broker will “shop around” for various lenders that provide the best deal in mortgage financing for their home buyer-client.

Upon hiring a broker, home buyers also expect their broker to be efficient in their job. As such, a broker's practice should exemplify this efficiency. The difficulty for brokers, however, is that with the amount of documents in a standard loan application, brokers have little time to organize and index these documents to meet the specifications of the various lenders while simultaneously meeting the efficiency expectations of their clients.

One or more embodiments of the present invention generally provide a system for electronically indexing hard copy documents related to a mortgage loan package. The system may store the indexed document on a repository (or database). The system may also facilitate the submission of the indexed document from a broker to a plurality of lenders. The system gives the broker the option of modifying or revising the indexed documents while stored on the repository to meet various requirements that are defined by the lenders. By providing a repository and providing broker the option of electronically modifying or creating new indexed documents from already electronically indexed documents, such a condition gives the broker the option of eliminating the first set of hard copy (or documents used to generate the initial set of indexed documents). As such, after the set of initial hard copy loan documents have been electronically indexed, it may not be necessary for the broker to keep the initial set of hard copy loan documents.

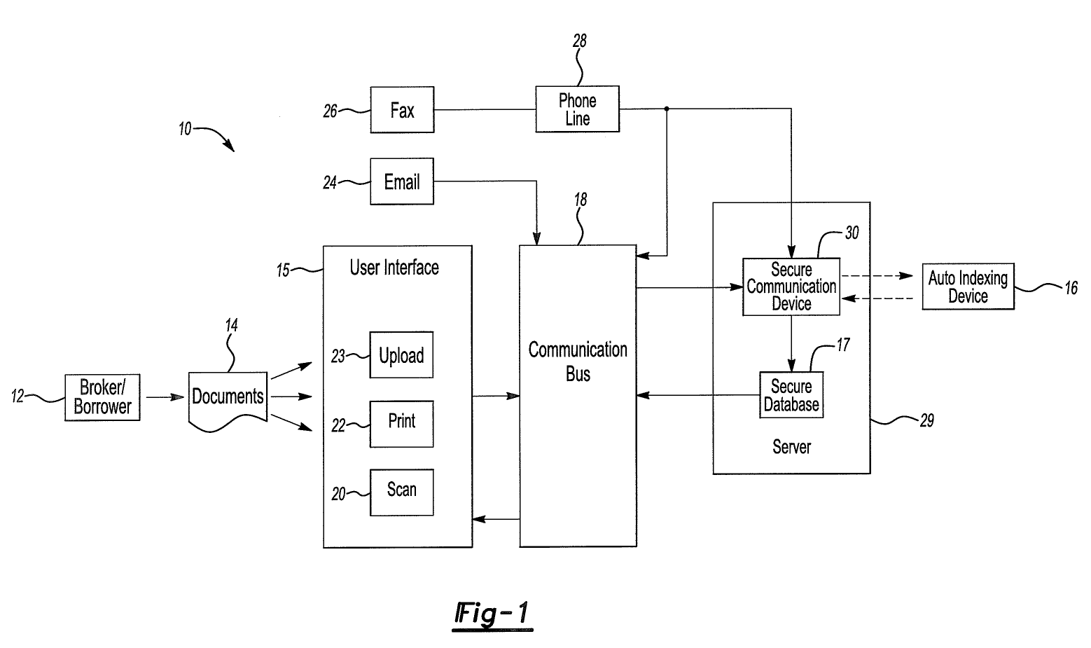

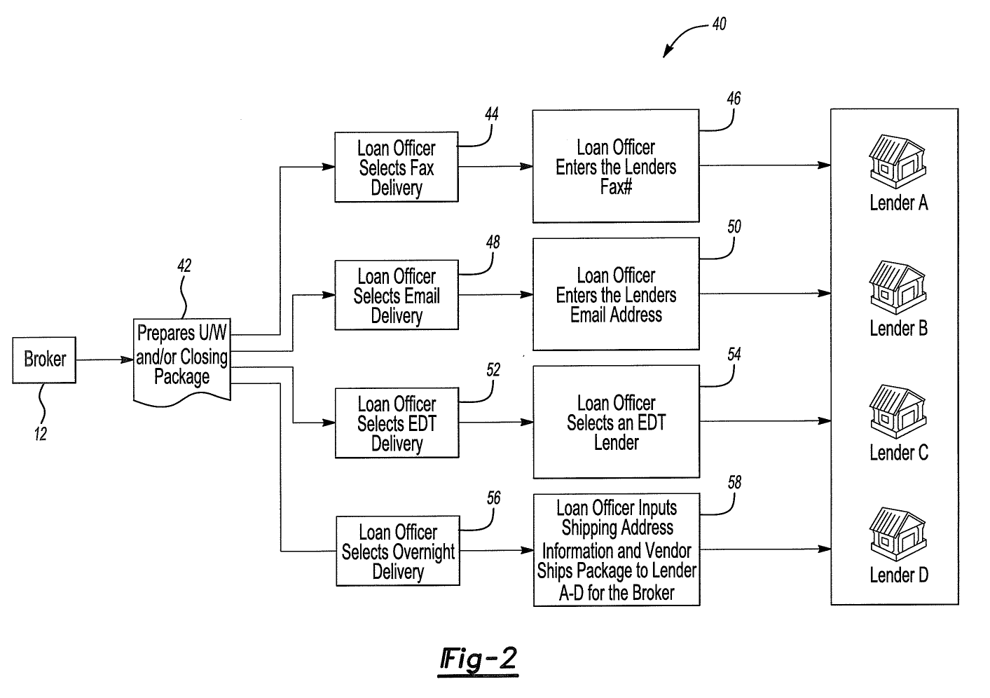

FIG. 1 is a diagrammatic view of an automatic indexing system 10 according to one of the various embodiments of the present invention. A broker 12 (or borrower) may prepare a number of documents 14 related to a loan package. It is generally contemplated that document 14 may include any such foreseeable mortgage related document that may comprise the loan package. In one example, the documents 14 may include, but are not limited to, a mortgage, a loan application, a good faith estimate, a Truth-in-Lending document, Housing and Urban Development (HUD) related documents, underwriting related documents, prequalification documents, and survey reports. The underwriting related documents may include, but are not limited to, bank statements, credit reports, a listing of assets, verification of employment forms, W2 forms and pay stub information that are correlated to the prospective borrower. The broker 12 sends the documents 14 to an auto-indexing device 16 via a communication bus 18 to obtain an indexed or classified listing of the documents 14 in an electronic format. Most or all of the actions performed by the broker 12 may also be performed by the borrower, such as fax and email. The broker 12 may be an agent acting on behalf of the borrower. The broker 12 is capable of accessing and/or modifying the indexed documents to facilitate sending the documents to any number of prospective lenders. The process will be discussed in more detail in connection with FIG. 2.

The system 10 includes a user interface 15 and a server 29. A broker may transmit the documents from the user interface 15 to the server 29 and the auto indexing device 16 via a communication bus 18. In one example, the communication bus 18 may be implemented as a Transmission Control Protocol/Internet Protocol (TCP/IP) or other generally foreseeable bus generally situated to facilitate data communication between two or more computers. The server 29 includes a secure communication device 30 and a secure database 17. The server 29 may control communication between the user interface 15, the secure communication device 30, the secure database 17, and/or the auto-indexing device 18. The auto-indexing device 16 may or may not be positioned with server 32. The positioning of the auto-indexing device 16 with respect to the server 29 may vary based on the particular implementation employed by the provider of the system 10. The secure transmission device 30 may be a network protocol that provides for a secure transfer of documents 14 to the auto-indexing device 16.

Prior to transmitting the documents to the auto-indexing device 16, the broker 12 may need to generate an electronic file folder. The broker 12 accesses the user interface 15 to initiate the process of setting up the electronic file folder. The user interface 15 may include login information and other fields, such as but not limited to broker name, file number, borrower name to allow the broker 12 to set up the electronic loan folder. The electronic loan folder is stored in the secure database 17 after the electronic loan folder is created. The secure database 17 may allow for any number of brokers to set up any number of electronic loan folders. The secure database 17 may be password protected to ensure that unauthorized users are prohibited from accessing electronic loan folders setup by the competing brokers. The broker 12 is generally required to setup the loan folder prior to sending the documents 14 to the auto-indexing device 16.

The user interface 15 may send a command to the server 29 so that the server 29 transmits the documents 14 to the auto-indexing device 16. The user interface 15 may be in the form of a web portal or a desktop client. As mentioned above, the broker 18 may set up the electronic loan folder prior to sending the documents 14 for indexing via the web portal or desktop client. The desktop client may be downloaded by the broker 12 onto a personal computer (PC) to facilitate the delivery of the documents 14 to the auto-indexing device 16. The user interface 15 may prompt the broker 12 to download the desktop client from the server 29 with an Internet connection via the communication bus 18. Alternatively, the desktop client may be programmed to a computer readable medium and accessible from the medium for download. The broker 12 may use the user interface 15 as a mechanism for transmitting the documents 14 to the auto-indexing device 16. The broker 12 may transmit the documents 14 to the auto-indexing device 16 for indexing prior to the indexed loan package being saved into to a particular loan folder in the secure database 17. The broker 12 may scan 20 the documents 14 to create an electronic version or electronic image of the documents via the desktop client. The broker 12 may also print 22 the documents 14 to create an electronic image of the documents 14 via the desktop client. The broker 12 may also upload 23 an electronic version of the documents 14 via the desktop client for transmission to the auto-indexing device 16. The format of the electronic version of documents 14 may be in one of the following: portable document format (PDF), a tagged image file format (TIFF), or other suitable file formats. The broker 12 may also upload 23 the documents 14 while in an electronic format directly from the user interface 15 and transmit the documents 14 by uploading the documents 14 and transmitting the documents 14 in the event the user interface 15 is in the form of a web portal. The broker 12 also has the option of sending the electronic version of the documents 14 to the auto-indexing device 16 via e-mail 24. The broker 12 may also send the documents 14 to the auto-indexing device 16 via fax 26 over a telephone line 28.

The auto-indexing device 16 may be configured to automatically separate and index the documents 14. For example, the auto indexing device 16 may separate the mortgages, the loan applications, the good faith estimates, the Truth-In-Lending documents, the HUD related documents and underwriting related documents into different sections or indexed documents. Each indexed document may be saved individually or saved together in electronic format. The auto-indexing device 16 may separate the documents 14 regardless of the type of electronic format that the document 14 is saved in. The auto-indexing device 16 may index the loan documents 14 based on content and/or format to improve records management for the broker 12. The reliability of the auto indexing device 16 in terms of accurately indexing the documents 14 increases as the auto-indexing device 16 reads more of the data in the documents. Such capability may need human intervention to upgrade the software of the auto-indexing device 16 based on the amount of data indexed. In one example, the auto-indexing device 16 may be a Kofax-Indicius auto indexing system produced by Kofax, Inc. of Irvine, Calif.

The auto-indexing device 16 reads, sorts, and organizes the documents 14 based on the document type to produce the indexed documents. The auto-indexing device 16 submits the indexed documents to the corresponding loan folder in the secure database 17 for storage. In one example, the auto-indexing device 16 submits the indexed documents as a TIFF file or other suitable format to the secure database 17 for electronic storage. The broker 12 may access and retrieve each indexed file in the electronic file folder via the user interface 15. The secure database 17 may be a digital warehouse or auto-classifier system, such as the Loan Katalyst system produced by Capsilon, Inc. of San Diego, Calif.

The broker 12 may move, modify, delete, or reclassify one or more of the indexed files in the secure database 17 as needed without having to obtain permission from any entity or party. In general, after the auto-indexing device 16 auto-indexes the documents 14, the documents are placed in corresponding loan folders and saved with a default name. The broker 12 has the option of reclassifying or renaming each file to correspond to the actual document without having to download the documents or generate a new document. For example, the loan application may be stored and saved in the loan folder and saved as “miscellaneous”. The broker 12 may access the loan folder via the user interface 15 and rename the document from “miscellaneous” to “loan application”. The broker 12 has the ability to drag and drop a portion of the indexed files or the entire set of indexed files into additional related transactional or business work flows which belong to the broker 12. The system 10 allows the broker 12 to eliminate paper storage of the documents 14 once the documents 14 have been indexed and saved into the secure database 17 for long-term storage. Alternatively, the broker 12 has the option of saving the indexed documents onto various PCs located at the broker's facility or onto one or more DVDs or CDs for storage.

The broker 12 may implement various security levels and grant access to the indexed documents to authorized personnel employed by the broker 12. The auto-indexing device 16 indexes the loan documents and returns the documents back to the broker 12 in an electronic format to allow the broker 12 to eliminate the process of adding bar codes to the loan documents in a loan package. The system 10 allows the broker 12 to eliminate all paper copies of the loan documents 14 unless otherwise required for business retention policies. The broker 12 has complete control over the documents and may electronically submit the documents 14 in any manner required by a particular lender.

FIG. 2 is a flow diagram of a loan delivery process 40 between the broker 12 and one or more lenders A-D. The system 10 generally allows the broker 12 to deliver the indexed loan package to the lenders A-D via the user interface 15. In step 42, the broker 12 prepares the underwriting and/or closing package with the desired indexed files stored in the corresponding loan folder in the secure database 17. In step 44, a loan officer affiliated with the broker 12 may fax the underwriting or closing package through the user interface 15. The user interface 15 allows the broker 12 the ability to fax the package to one or more of the lenders A-D. In step 46, the loan officer enters the fax number via the user interface 15 to any one or more lenders A-D to complete the fax transmission and to initiate the transaction between the broker 12 and one or more of the lenders A-D.

In step 48, the loan officer selects e-mail delivery in the user interface 15 for transmission of the underwriting or closing package. In step 50, the loan officer also enters the corresponding e-mail addresses via the user interface 15 for the one or more lenders A-D and attaches the corresponding underwriting or closing package from the loan folder (in the secure database 17) or any other electronic storage medium where the documents 14 may be stored. The loan officer sends the e-mail and the attached underwriting or closing package to any one or more of the lenders A-D to initiate the transaction between the broker 12 and the one or more of the lenders A-D.

In step 52, the loan officer selects an electronic delivery transfer (EDT) via the user interface 15 for the transmission of the underwriting or closing package. In step 54, the loan officer may select the address for a particular lender A-D via the user interface 15 to upload and transmit the underwriting or closing packages to the one or more lenders A-D. For example, the loan officer may electronically attach various indexed files while in the user interface 15 from the loan folder which comprise the underwriting or the closing package to the various fields on the one or more URLs of the one or more lenders A-D.

In step 56, the loan officer selects an overnight delivery of the underwriting or closing package via the user interface 15. In step 58, the loan officer selects overnight delivery from a menu and inputs the shipping address information. When completed, such information is transmitted to a shipping vendor which may print the relevant information and ship the package to the lenders A-D for the broker 12. Additional implementations may include the user interface 15 preparing the relevant shipping information where the broker 12 ships the package in the event a shipping vendor is not used or available. While the user interface 15 generally facilitates the delivery of the loan package in indexed form to the one or more lenders A-D, the broker 12 may also perform such actions independent of the user interface 15. The user interface 15 may be beneficial for transmitting the loan package since the loan documents or indexed documents may be easily accessible via the user interface 15.

Customized skins and logos may be added to the user interface 15 which includes a corporate name for the auto-indexing device 16. An “export to broker” feature may be added to allow brokers to export loan folders into PCs located at the broker's 12 establishment for local storage. On-line-storage may be given to brokers 12 to allow such brokers 12 to store indexed documents for a defined period of time on the secure database 17. On-line help options may be included with the user interface 15 to assist brokers 12 in creating the electronic loan folders in the database 17 and to also assist brokers in uploading various loan documentation.

Training modules may be given to brokers to train broker personnel with the submission and accessing of the loan documents. The system 10 may also be integrated with the following packages and not limited to E-mortgage, E-closings, E-signing, E-recordings and E-disclosures. E-mortgage generally pulls loan documents which exist in an electronic format and makes such documents available to the buyer or seller so that the buyer or seller may electronically sign (e-sign) loan documents during a closing for the sale and purchase of real estate. System loan folder templates may be established which may include various data fields that require data from the broker 12 to create the electronic loan folders in the database 17.

As noted in connection with step 56, the system 10 may provide a print to ship option for overnight delivery. For example, the broker 12 (or borrower) may select the print to ship overnight delivery via the user interface 15 and select desired documents from the loan folder for automatic delivery to a particular lender A-D.

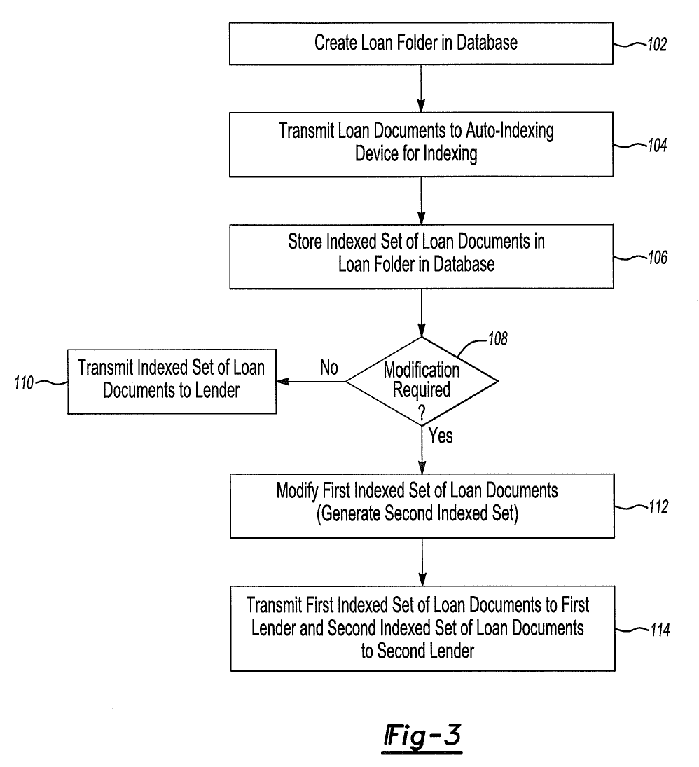

FIG. 3 shows a flow diagram representing the modification feature of the present invention according to one of the various embodiments of the present invention. According to one embodiment, the modification of loan documents and/or loan document folders may occur in secure database 17. From the user interface 15, one or more loan folders may be created in the database 17 as in block 102. As further described below, loan folders may be organized according to cabinets and offices. In block 104, one or more loan documents 14 and/or document sets may be transmitted to the auto-indexing device 16 for indexing as described in connection with FIG. 1. In block 106, upon indexing the transmitted loan documents 14, a first indexed set of loan documents may be generated and transmitted from auto-indexing device 16 to server 29 for storage within the secure database 17. The indexed loan documents may be transmitted to the loan folders and identified by a unique folder ID.

Once the documents have been stored, a user (e.g., broker/borrower) at the user interface 15 may review the indexed documents stored in the secure database 17 for accuracy of content (e.g., the documents are placed in the right folder) and/or format (e.g., the documents are named correctly). If the documents are accurate and require no modification as in block 108, the user may then transmit the loan documents to a lender for review as in block 110. The user may then await a decision from the lender.

In block 112, if the loan documents do require modification, however, as in block 108, the user while at the user interface 15 may modify the loan documents stored in secure database 17. The user may modify the documents directly without downloading a paper copy of the indexed documents or resubmitting the revised copy as a new document for indexing again by the auto-indexing device 16. In one embodiment, as described below, there may be restricted access among personnel employed at the broker 12 to the documents in database 17 for modification purposes based on predetermined access levels. In another embodiment, all users may be provided full access to loan documents stored in database 17. Upon making the modifications, a revised version of the indexed loan documents may be generated as in block 112. In one embodiment, where lenders have different requirements associated with loan documents, a second set of indexed documents may be generated for conforming to the different lender requirements. Accordingly, as represented in block 114, a first set of indexed documents may be sent to a first lender according to first lender's requirements and a second set of indexed documents may be sent to a second lender according to the second lender's requirements. Upon transmission of the loan documents to a lender, the user may then wait for a decision from the lender.

The system 10 may be integrated with any loan original system (LOS). The LOS may provide for a number of beneficial uses for the broker 12. Such uses are, but not limited to, the capability to generate documents, the ability to order mortgage services (e.g., appraisals, flood certifications, title, surveys, and/or credit reports), direct links with an automatic underwriting system (AUS) for loan approval and fraud detection via DISSCO™ capabilities with regards to a loan officer name, appraisals, and/or the title. The LOS generally provides for automatically generating a number of documents related to mortgage services, AUS findings when complete, and fraud detection. By integrating LOS capability with the system 10, the system 10 may easily retrieve such documents and make the documents accessible to the brokers and/or lenders.

The system 10 may be integrated with a stand alone multi-functional device. For example, the multi-functional device may include an all-in-one printer/scanner/fax machine apparatus that is capable of being connected directly to the secure database 17. Such an apparatus may allow the documents to be directly uploaded to the loan folder. Such a characteristic may eliminate the need to require inputting the fax number and/or a cover sheet when faxing or scanning the documents. Instead, the system 10 generally allows the broker 12 to type in the loan folder number for automatic transmission of the documents while printing, scanning or faxing the documents to the auto-indexing device 32.

The system 10 may be adapted to perform datastream capturing. With datastream capturing, the system 10 may eliminate the need to key in various data that includes and is not limited to the loan amount, the borrower's name, the borrower's social security number, address, date of birth. All of the needed or desired data may be pulled directly from the imaged documents.

The system 10 may perform online collaboration between mortgage parties. For example, the system 10 may be configured to provide online collaboration throughout the entire loan process between the borrower and the broker, the broker and the lender, and the lender and the investor.

The system 10 may integrate various web services. For example, the system 10 may be integrated to operate with the following web services and not limited to Google™ maps, Zillow™, and broker forums.

The system 10 may be adapted to standardize addresses for properties. For example, the system 10 may verify with the United States Postal Service (USPS) that the loan property address inputted by the broker 12 into the system 10 is correct.

The system 10 may provide for closing package generation. For example, the ability to create the closing package from the user interface 15 may be based on specific requirements of the intended lender and/or investor.

The system 10 may be adapted to provide for auto-workflow notification. For example, the user interface 15 may send e-mail alerts to various individuals or departments when a loan folder is redirected from one location to another.

The system 10 may be integrated with various lender underwriting systems. For example, the broker 12 or borrower may create document stacking templates in the user interface 15 to adhere to various lender guidelines. The broker 12 may select the lender of choice and the documents generally required by the lender of choice may be automatically imported into the lender's underwriting system.

The system 10 may be integrated with various pricing engines. For example, the system 10 may provide for lender rate sheets to be imported directly into the user interface 15 for easy retrieval and comparisons.

The system 10 may provide for a turn time integration. Such an integration may provide imported underwriting turn times from various lenders.

The system 10 provides for data to be stored on compact discs (CDs) or DVDs. For example, an entity may electronically store indexed loan packages for the brokers 12 on CDs or DVDs in the event brokers 12 no longer desire to keep the loan packages in the electronic loan folders in the secure database 17. The entity may store such information long term or on a monthly or quarterly basis. In one example, the entity may be Paperless Office Solutions, Inc. d.b.a. DocVelocity of Troy, Mich.

The system 10 may be utilized for securitization. For example, the system 10 may allow the broker 12 to receive and correct errors and omissions (E&O's) from various lenders.

The system 10 may also give the broker 12 the ability to check necessary information via specific mobile devices (e.g., cell phone, Blackberry™, and/or I-Phone™ or other such devices generally known and/or recognized as a various mobile device for a person).

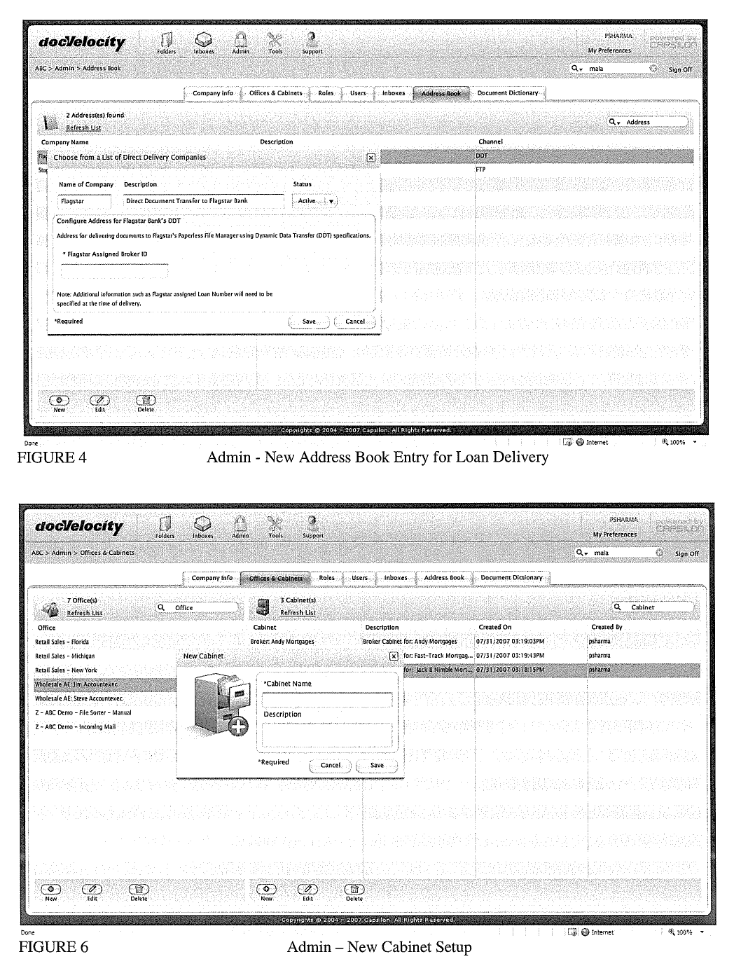

FIGS. 4-24 depict various embodiments of Graphical User Interfaces (GUIs) generated within user interface 15. FIGS. 4-24 generally illustrate a number of GUIs which correspond to functions provided by the system 10 and the operations as performed in the loan delivery process between the broker 12 and the one or more lenders A-D according to one of the various embodiments of the present invention. The figures will be described in further detail below.

FIGS. 4-10 represent illustrative embodiments of GUIs displayed to, for example, an administrator. FIG. 4 illustrates a feature of the present invention in which a user (e.g., the administrator) may set up the manner of delivery for the loan documents to another party (e.g., a lender or a borrower). Non-limiting examples of the manner of delivery include electronic mail, electronic delivery transfer (e.g., file transfer protocol), fax, and/or electronic print-to-ship. In the embodiment represented in FIG. 4, an electronic print-to-ship delivery is presented. It should be understood that the manner of delivery may include various combinations of delivery methods.

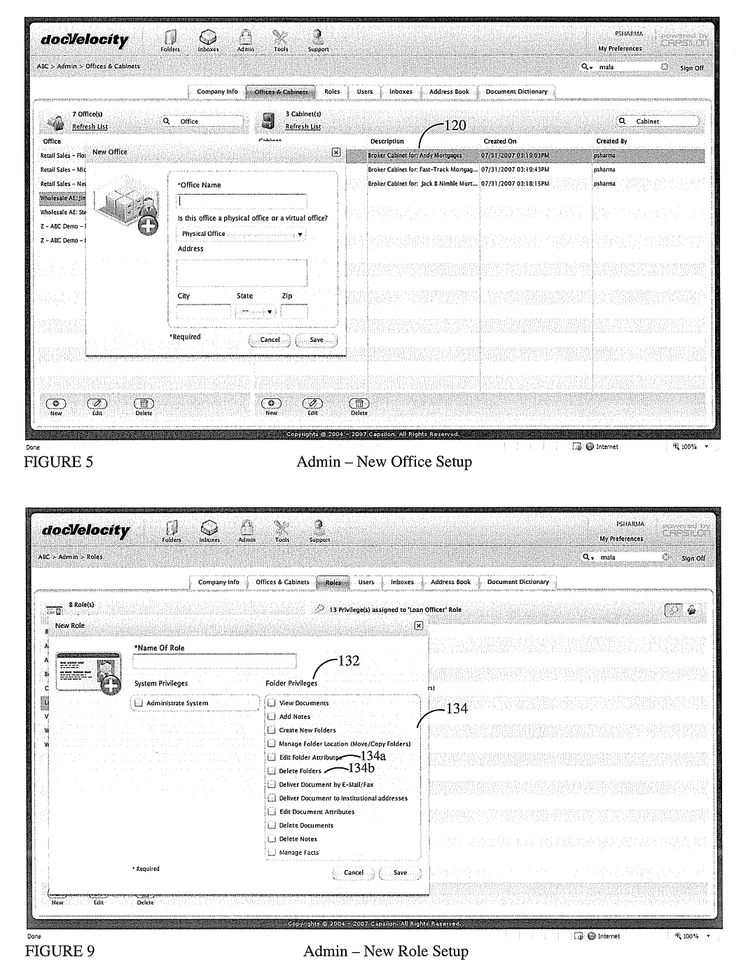

FIG. 5 represents an illustrative embodiment of a GUI for identifying a new broker office and associating a new broker office with the automatic indexing system 10. FIG. 6 exemplifies the creation of a new cabinet associated with an office for electronically storing loan documents. As represented in FIG. 5, the broker office may be a physical (i.e., brick-and-mortar) and/or virtual (i.e., click-and-mortar) office. A number of cabinets 120 may be associated with each office. Cabinets may be used to store and organize loan folders and loan folders may be used to store and organize loan documents within secure database 17. Thus, a hierarchy of document organization may be created in secure database 17 in which, for example, loan documents are organized into loan folders, loan folders are organized into cabinets, and cabinets are organized by broker offices.

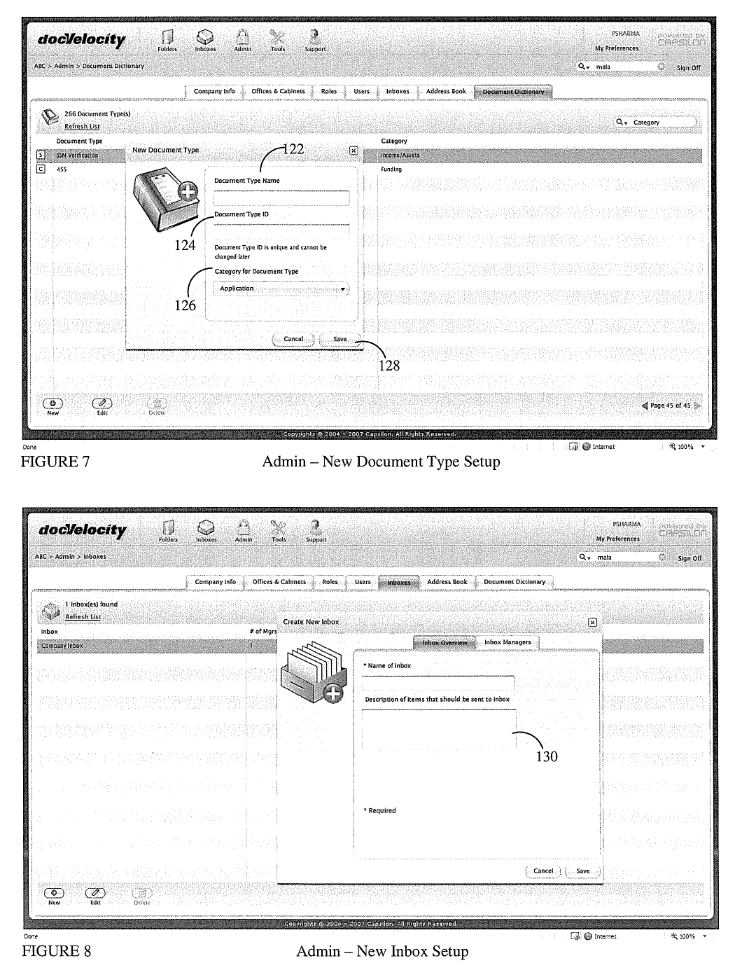

FIG. 7 exemplifies a GUI illustrating another feature of the present invention according to one of its various embodiments. Namely, FIG. 7 represents the feature of document renaming/modification an existing set of loan documents that were already indexed. Such a feature is one of various examples of the capability given to a user (e.g., a broker) for modifying incoming or outgoing loan documents. For example, through this feature, a broker may modify the name of a new document within the first indexed set of documents already indexed by the auto-indexing device 16 according to office protocol or industry standards. If an indexed document is misnamed or the recipient wants to rename the document, the user may enter a document type name 122, a document type ID 124, and a document type category 126 for renaming and identifying the incoming document. In one embodiment, any user including, but not limited to, the administrator associated with a particular brokerage office may rename a document. Upon selecting “save” button 128, the renamed document will be saved to the secure database 17.

FIG. 8 represents a GUI for generating an inbox for incoming documents (e.g., via fax, electronic mail, etc). Instructions may be programmed to a computer readable medium (not shown) housed in server 29 for directing incoming documents to its assigned inbox based on the description of the items defined in field 130.

FIG. 9 shows a GUI for assigning roles to users of system 10. Non-limiting examples of roles assigned to users may be “Office Manager,” “Loan Manager,” and/or “Owner.” Each role may be assigned a different access level to system 10 (e.g., secure database 17) for modifying or deleting loan documents and/or loan folders. Access privileges may be assigned as represented in field 132, by, for example, highlighting one or more privileges from privilege list 134. For example, an “Owner” may be given the highest privilege level such that he or she may be given all privileges such as editing folder attributes 134a or deleting folders 134b. In one embodiment, unrestricted access to secure database 17 for modifying, deleting, or in any other way altering the content within secure database 17 may be provided to any number of users of system 10.

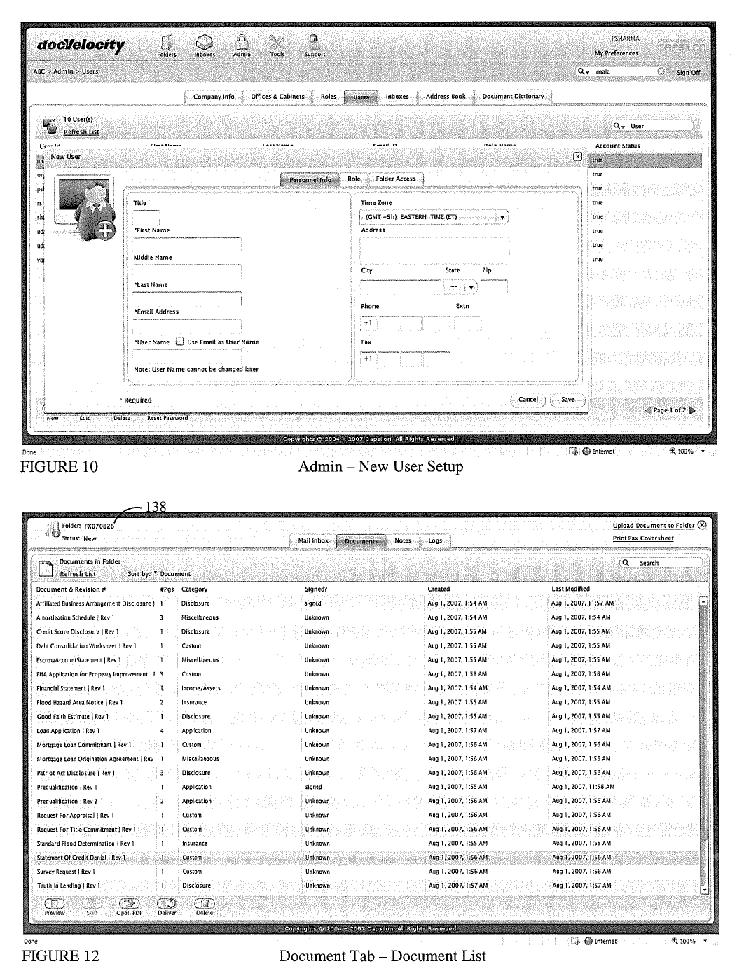

FIG. 10 represents a GUI according to one of the various embodiments of the present invention for creating a new user of system 10.

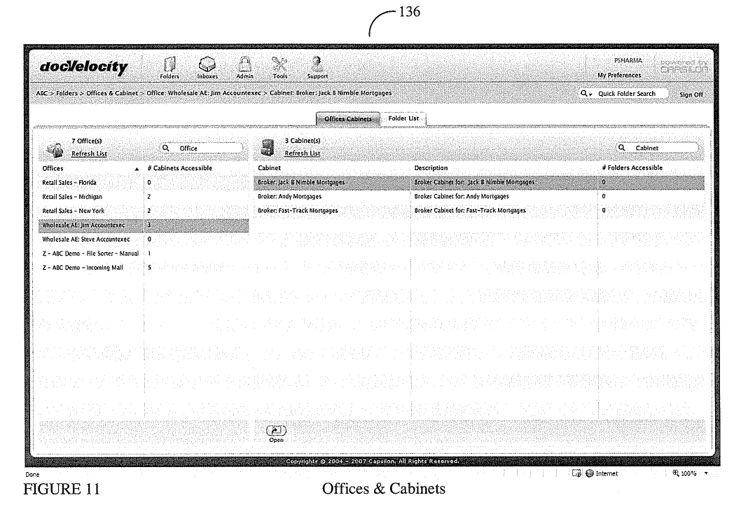

FIGS. 11-24 show exemplary embodiments of GUIs presented to a user (e.g., a non-administrator) at user interface 15. FIG. 11 represents one exemplary embodiment of a “homepage” as displayed to a user (e.g., broker/borrower). GUI 136 may show one or more offices associated with the user and the cabinets associated with the one or more offices. As described above, loan documents may be organized using cabinets and offices. FIG. 12 shows an exemplary GUI displaying a plurality of documents within an already indexed set of documents that may be stored in a loan folder. Each loan folder may be associated with a unique loan folder ID 138 for identification. Furthermore, there may be one or more selectable buttons for accomplishing a variety of actions. Non-limiting examples may include previewing one or more documents, opening one or more documents within the indexed set of documents in PDF format, delivering one or more document (e.g., via fax, electronic mail, etc) to one or more of the lenders A-D and/or deleting one or more documents.

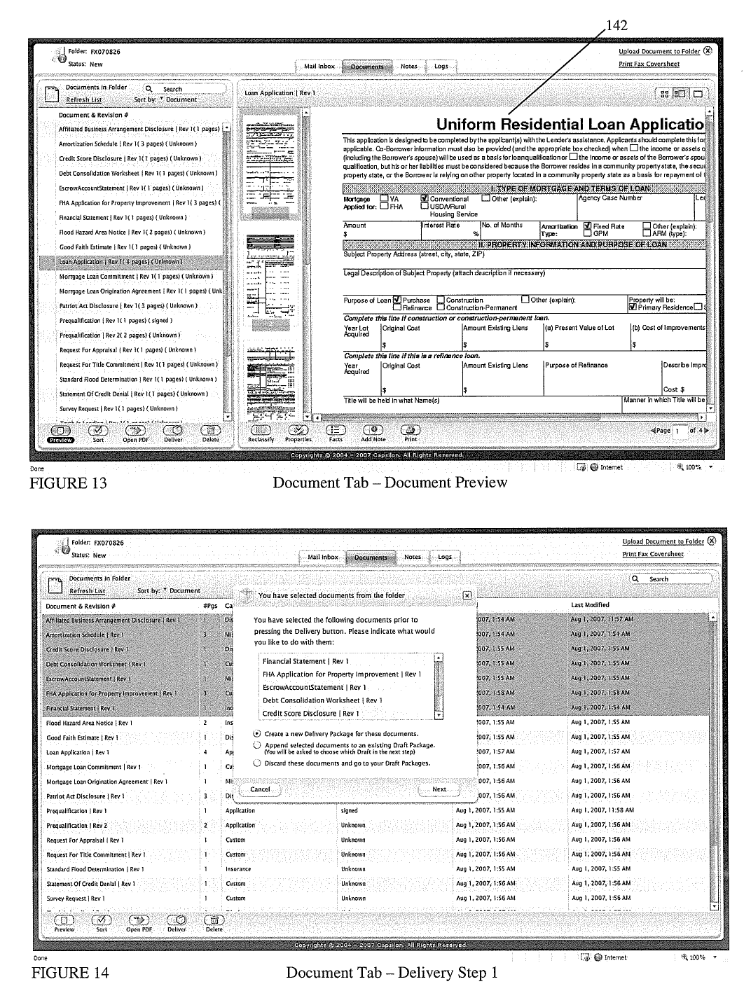

FIG. 13 shows an exemplary GUI displayed to a user (i.e., broker/borrower) upon selecting one or more documents from the indexed set of documents in a loan document folder. Such documents shown in 140 generally correspond to an indexed section. The indexed set of documents may be defined to include one or more of the indexed sections. As shown in FIG. 13, a user may select “Loan Application” from field 140 and, upon selection, a “Uniform Residential Loan Application” may be displayed to the user as in 142. In one embodiment, documents (or the indexed sections) in field 140 may be modified (e.g., re-organized) through, for example, a “drag and drop” feature. The drag and drop feature may allow the broker the ability to arrange the indexed sections in the field 140 in any order generally required by a particular lender. The broker may optionally delete or reclassify one or more of the indexed sections from the field 140 to meet any such lender requirement. The broker may save any changes made to the indexed section and save an additional indexed set of documents. The broker may continue to store the additional set of indexed documents in the current loan folder or create a new loan folder to store the additional indexed set of documents therein. Thus, a broker is provided the flexibility of being able to re-organize and modify loan documents according to lender requirements.

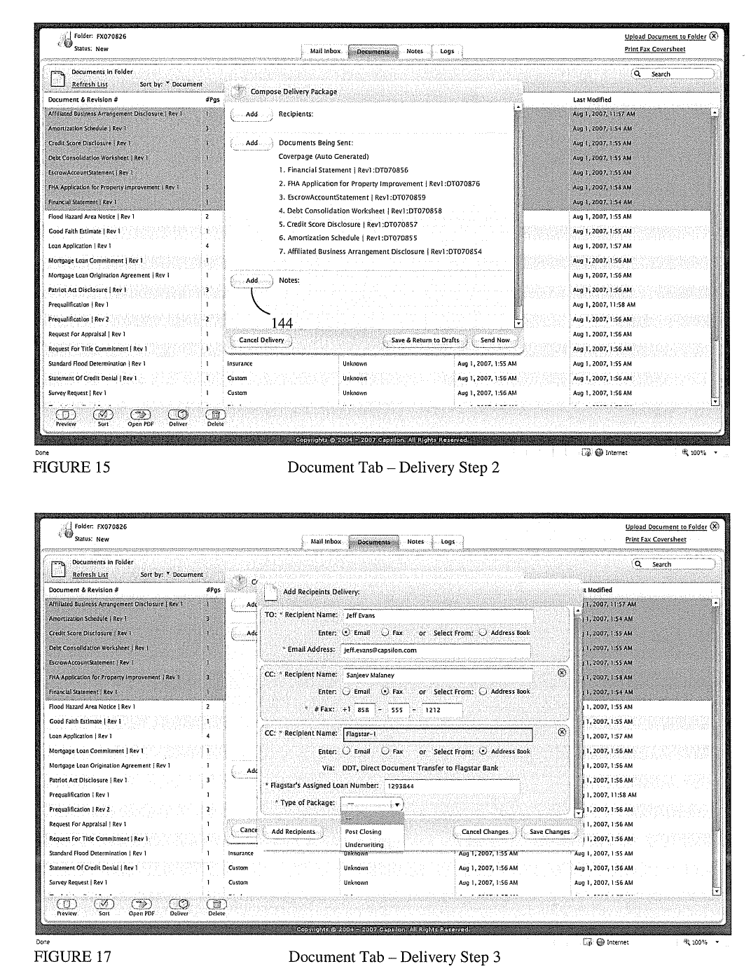

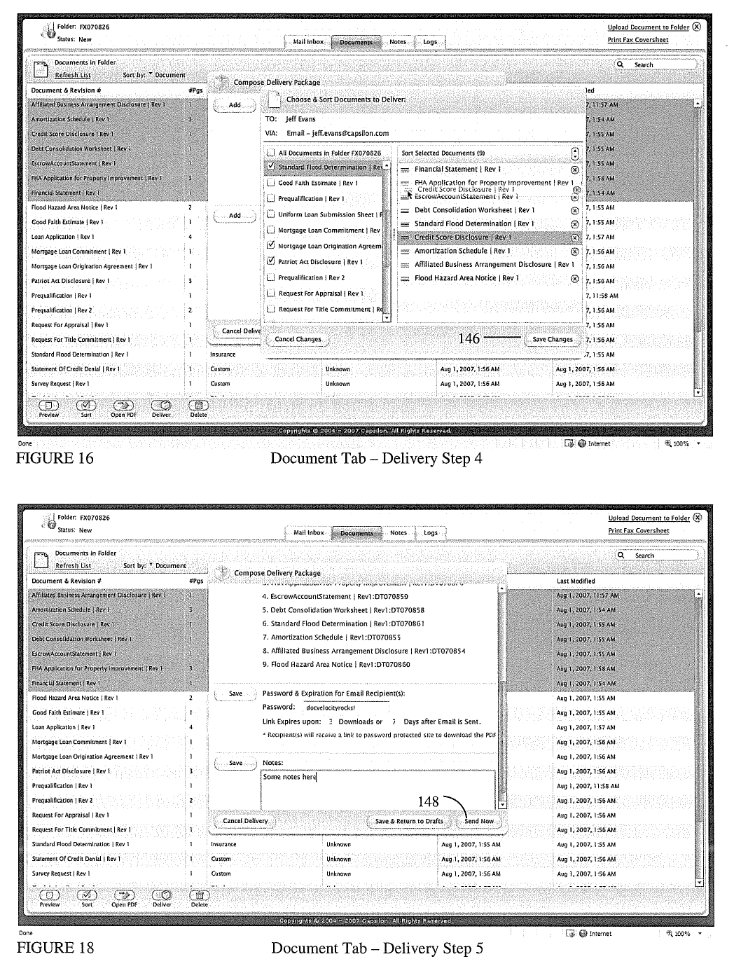

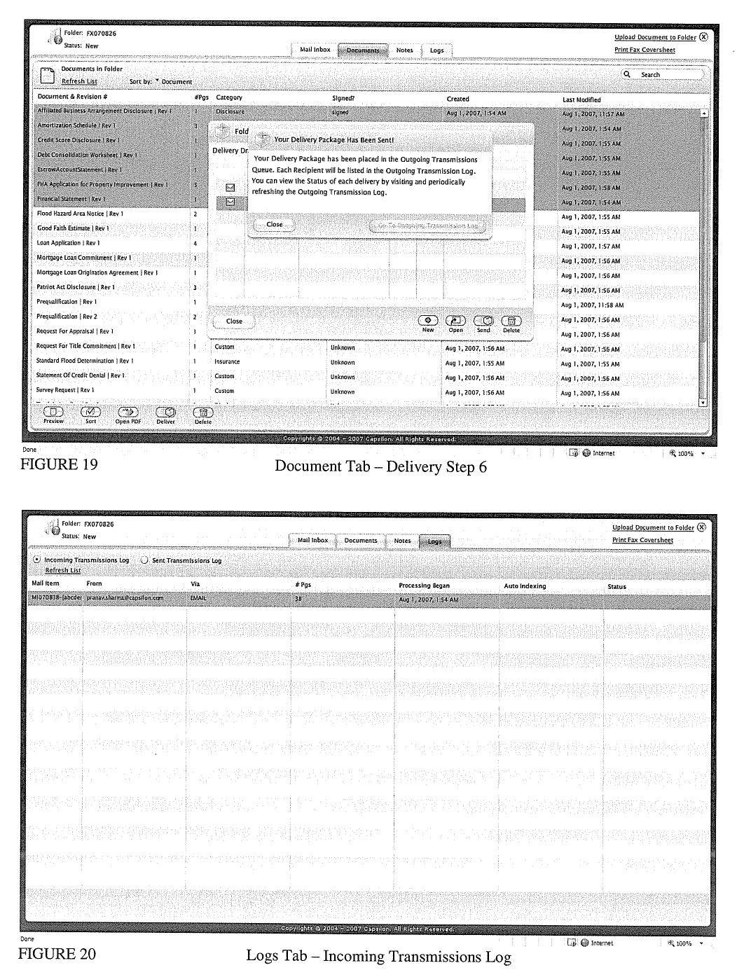

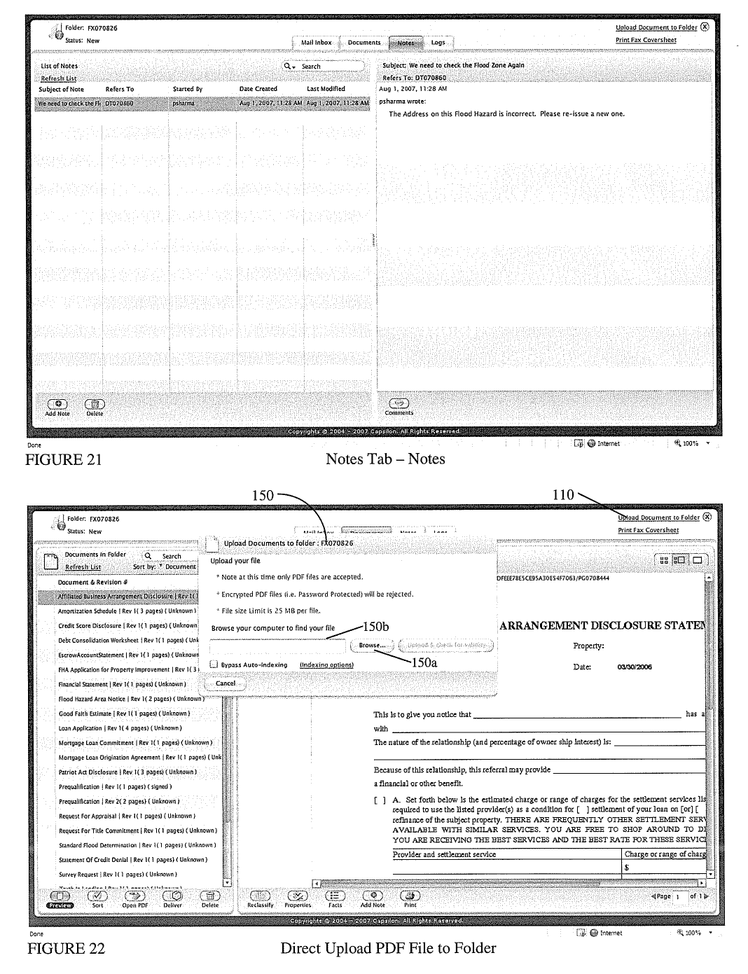

FIGS. 14-19 show exemplary GUIs representing, according to one of the various embodiments of the present invention, the delivery of loan documents to a lender and/or borrower from the user interface 15 via server 29. As shown in FIG. 14, a user (e.g., the broker) may select one or more documents for delivery as a “package” of loan documents. Upon making the selection, the broker may be presented with a confirmation page of the documents being sent as represented in FIG. 15. If the broker chooses to add more documents, the broker may select the “Add” button 144 and may be directed to a page as represented in FIG. 16 to include additional documents. Upon selecting the documents and selecting the “Save Changes” button 146 (see FIG. 16), the broker may then enter the destination of the documents and the manner of delivery as represented in FIG. 17. If needed, the broker may add notes to the recipient as represented in FIG. 18. Upon selecting the “send now” button 148 (see FIG. 18), according to one embodiment, the broker may be directed to a display, as represented in FIG. 19, confirming the submission of the loan document package to the recipient. As represented in FIG. 20, according to one embodiment, a log may be generated of the documents sent and received at system 10. Furthermore, as represented in FIG. 21, users may include notes regarding particular loan documents. For example, the notes may be useful in generating internal communications and reminders regarding a loan document set.

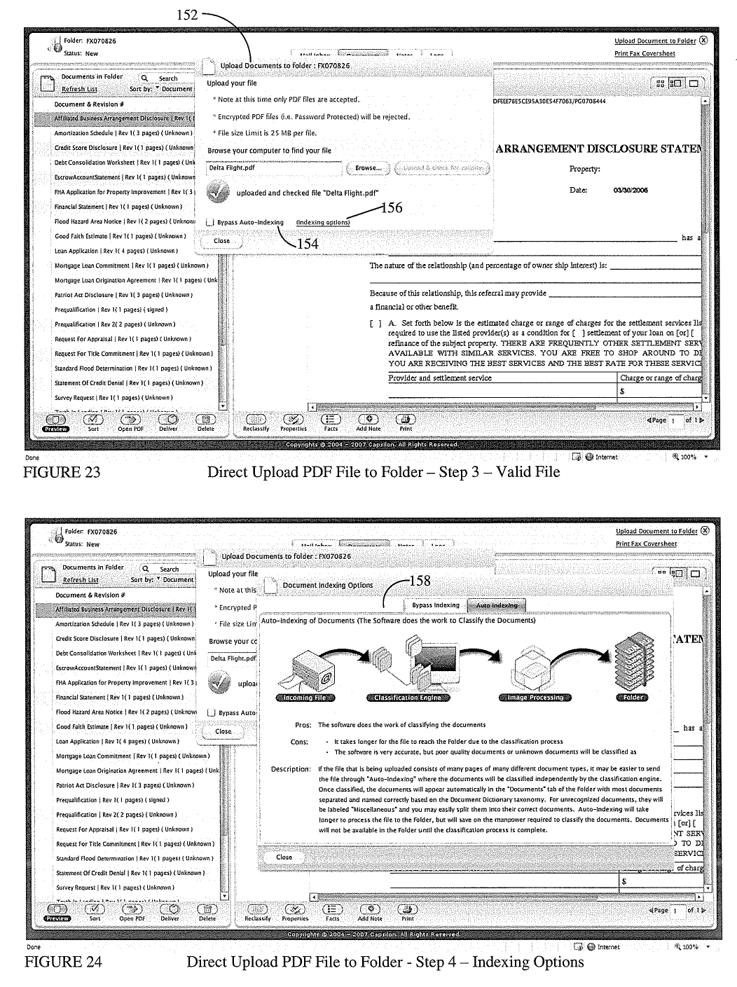

In one embodiment, as represented in FIGS. 22-24, additional documents may be added to the loan folder (e.g., in this embodiment, loan folder with unique ID number FX070826). As shown in FIG. 22, the user (e.g., a broker) may add documents to the loan folder by selecting hyperlink 110 which may generate window 150 for searching secure server 17 (e.g., by selecting selectable button 150a). Upon selecting selectable button 150a, the file path name may be displayed in field 150b. Another selectable button (not shown) may be selected for adding one or more documents to the loan folder which may generate window 152 (FIG. 23) identifying the status (e.g., successful or unsuccessful) of the file upload.

In one embodiment, upon uploading the new document to the loan folder, the user may be presented with an option to bypass the auto-indexing feature as represented in feature 154. If the user chooses to bypass auto-indexing, the documents may be stored in secure database 17 as uploaded to the system 10 (i.e., without any indexing). If the user chooses to auto-index the documents (i.e., not to bypass), however, the user may select hyperlink 156 which may generate window 158 (FIG. 24) which will cause the documents to be auto-indexed as described above.

In a further embodiment, a user may be given the capability of searching secure database 17 for particular loan documents. The search results may be displayed to the user according to the unique folder ID assigned to each loan folder.

The system 10 and the process 40 generally provides for a friendly web-based paperless solution to the broker community that may allow brokers to seamlessly auto-index all documents, digitally store such documents, provide a paperless workflow for all of the broker's loans, and maintain the flexibility to sell the loans to any investor of the broker's choice.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for electronically modifying a plurality of loan documents associated with a loan broker, the system comprising:
a first computer configured to:
receive the plurality of loan documents from a second computer;
transmit the plurality of the loan documents to an auto-indexing device such that the auto-indexing device indexes the plurality of the loan documents to generate a first indexed set of loan documents;
receive the first indexed set of loan documents from the auto-indexing device;
store the first indexed set of loan documents in a database; and
enable the second computer to electronically modify the first indexed set of loan documents to generate a second indexed set of loan documents.

2. The system of claim 1 wherein the first computer is further configured to transmit the first indexed set of loan documents to a first lender in response to a first command from the second computer.

3. The system of claim 2 wherein the first computer is further configured to transmit the second indexed set of loan documents to a second lender in response to a second command from the second computer.

4. The system of claim 1 wherein the first computer is further configured to electronically modify the first indexed set of loan documents by deleting at least a portion of the first indexed set of loan documents in response to a command from the second computer.

5. The system of claim 1 wherein the first computer is further configured to electronically modify the first indexed set of loan documents by removing at least a portion of the first indexed set of loan documents in response to a command from the second computer.

6. The system of claim 1 wherein the first computer is further configured to generate a loan folder prior to transmitting the plurality of loan documents to the auto-indexing device in response to a command from the second computer.

7. The system of claim 6 wherein the first computer is further configured to store at least one of the first or second indexed set of loan documents in the loan folder.

8. The system of claim 1 wherein the first computer is further configured to transmit a preselected portion of the first indexed set of loan documents to a first lender in response to a first command from the second computer.

9. The system of claim 8 wherein the first computer is further configured to transmit a preselected portion of the second indexed set of loan documents to a second lender in response to a second command from the second computer.

10. The system of claim 1 wherein the first computer is further configured to provide to the second computer unrestricted access to the database for electronically modifying the first indexed set of loan documents.

11. The system of claim 1 wherein the first computer is further configured to establish predefined access levels to the database with respect to the manner in which the first computer electronically modifies the first indexed set of documents in response to a command from the second computer.

12. The system of claim 1 wherein the first computer is a server.

13. A system for electronically modifying a plurality of loan documents associated with a loan broker, the system comprising:
a first computer configured to:
transmit the plurality of loan documents to a second computer to generate a first indexed set of loan documents by indexing the plurality of loan documents and for storing the first indexed set of loan documents in the second computer; and
command the second computer to electronically modify the first indexed set of loan documents to generate a second indexed set of loan documents, the second indexed set of loan documents being stored on at least one of the first and the second computers.

14. The system of claim 13 wherein the first computer is further configured to command the second computer to transmit the first indexed set of loan documents to a first lender.

15. The system of claim 14 wherein the first computer is further configured to command the second computer to transmit the second indexed set of loan documents to a second lender.

16. The system of claim 13 wherein the first computer is further configured to command the second computer to transmit either of at least the first or second indexed set of loan documents to at least two lenders.

17. The system of claim 13 wherein the first computer is further configured to command the second computer to electronically modify the first indexed set of loan documents by renaming one or more sections of the first indexed set of loan documents or by deleting one or more sections of the first indexed set of loan documents.

18. A system for electronically transmitting a plurality of loan documents for a loan broker to one or more lenders, the system comprising:
a first computer configured to:
receive the plurality of loan documents from a second computer;
transmit the plurality of the loan documents to an auto-indexing device such that the auto-indexing device indexes the plurality of the loan documents to generate a first indexed set of loan documents;
receive the first indexed set of loan documents from the auto-indexing device;
store the first indexed set of loan documents therein; and
transmit the first indexed set of loan documents to a first plurality of lenders in response to a first command from the second computer.

19. The system of claim 18 wherein the first computer is further configured to electronically modify the first indexed set of loan documents to produce a second indexed set of loan documents while the first indexed set of loan documents are stored in the first computer.

20. The system of claim 19 wherein the first computer is further configured to transmit the second indexed set of loan documents to a second plurality of lenders in response to a second command from the second computer.
